(19) United States
(12) Patent Application Publication
(10) Pub. No.: US 2025/0037011 A1
(43) Pub. Date: Jan. 30, 2025

(54) USING A THEME-CLASSIFYING MACHINE-LEARNING MODEL TO GENERATE THEME CLASSIFICATIONS FROM UNSTRUCTURED TEXT

(71) Applicant: Chime Financial, Inc., San Francisco, CA (US)

(72) Inventors: Sidi Sun, Newark, CA (US); Lei Pei, Sunnyvale, CA (US)

(21) Appl. No.: 18/357,487

(22) Filed: Jul. 24, 2023

(51) Int. Cl. G06N 20/00

(52) U.S. Cl. CPC G06N 20/00

(57) ABSTRACT

The present disclosure relates to systems, non-transitory computer-readable media, and methods for generating a theme classification from unstructured text. In particular, in one or more embodiments, the disclosed systems receive experience data comprising an experience score and unstructured text. The disclosed systems can utilize a theme-classifying machine-learning model to generate a theme classification from the unstructured text and associate the theme classification to the experience score. Moreover, in some embodiments, the disclosed systems can determine and take actions based on the theme classification.

### BACKGROUND

Recent years have seen significant improvement in the popularity and usage of online transaction systems. As online transactions have increased, conventional systems have increasingly employed various rating systems to receive input from users of online transaction systems. For example, some conventional systems use traditional methods of gathering information, such as surveys, to understand the customer experience. To illustrate, in these conventional systems, users complete surveys of defined questions directing responses toward the user experience with the online transaction system. In other conventional systems, users respond to a survey by selecting an experience score and inputting text associated with the experience score.

Although conventional systems can receive information from clients regarding their user experience, these systems have a number of problems in relation to the accuracy, efficiency, and flexibility of implementing computing devices. For instance, conventional systems are inaccurate because they receive responses to questions that categorize the user experience as a whole, losing valuable user insights relating to discrete portions of the online transaction experience. Conventional systems that receive a survey response with an experience score and associated free input text are inaccurate because they do not relate the experience score to specific product features or experiences. Instead, these systems broadly relate the experience score to the product as a whole and miss specific aspects of the user experience that the experience score actually reflects. For example, users may respond with a low experience score even though they are generally happy with the experience. In such cases, users are simply unsatisfied with only a portion of the user experience. These conventional systems cannot link the low score with the specific feature with which the user is unsatisfied. Hence, the experience score becomes an inaccurate data point.

Other conventional systems use surveys wherein users answer defined questions to gather information about specific portions of the user experience. However, these systems are inefficient. In these systems, users answer a question on one graphical user interface and are directed to a successive graphical user interface to answer another question. This process repeats until the user completes the survey or the conventional system receives the desired information. As a result, these conventional systems require a tremendous about of time and computing resources to complete.

Furthermore, conventional systems are inaccurate because they only provide insights from a single customer experience survey. Users often go to the most accessible source to give positive feedback or air grievances, such as leaving a review or a comment on social media. By limiting data to survey responses, conventional systems miss users who may have valuable insights into the system but did not receive the survey or elected to provide information about their user experiences in other venues. Not only does this offer an incomplete picture of the experience of a wide range of customers, but it also misses users that feel they already gave information by responding in other forums.

Moreover, conventional systems are inflexible because when gathering information through surveys, they only ask questions and solicit feedback about known issues and problems. In this way, conventional systems are limited to only that which was previously known and cannot identify additional issues or problems without expending additional time and computing resources. These, along with additional problems and issues, exist with regard to conventional user experience systems.

### BRIEF SUMMARY

Embodiments of the present disclosure provide benefits and/or solve one or more of the foregoing or other problems in the art with systems, non-transitory computer-readable media, and methods by utilizing a theme-classifying machine-learning model to generate theme classifications from unstructured text. For example, the disclosed systems can receive experience data comprising an experience score associated with unstructured text. The disclosed systems can further utilize a theme-classifying machine-learning model to generate a theme classification for the unstructured text and associate the theme classification with the experience score. In one or more embodiments, the disclosed systems can perform one or more actions based on the associated theme classification and experience score.

Additional features and advantages of one or more embodiments of the present disclosure are outlined in the description which follows and, in part, will be obvious from the description or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which an experience classification system operates in accordance with one or more embodiments.

FIG. 2 illustrates an example sequence flow for generating a theme classification in accordance with one or more embodiments.

FIG. 3 illustrates training a theme-classifying machine-learning model to generate theme classifications in accordance with one or more embodiments.

FIG. 4 illustrates generating theme classifications for unstructured text utilizing a theme-classifying machine-learning model in accordance with one or more embodiments.

FIG. 5 illustrates utilizing a theme classification to perform additional actions and determine additional actions based on the theme classification in accordance with one or more embodiments.

FIG. 6 illustrates performing actions based on associated theme classifications and experience scores in accordance with one or more embodiments.

FIG. 7 illustrates an example series of acts for generating a theme classification for unstructured text in accordance with one or more embodiments.

FIG. 8 illustrates a block diagram of a computing device for implementing one or more embodiments of the present disclosure.

FIG. 9 illustrates an example environment for an inter-network facilitation system in accordance with one or more embodiments

### DETAILED DESCRIPTION

This disclosure contains one or more embodiments of an experience classification system that utilizes machine-learning models to generate theme classifications for unstructured text. More specifically, the experience classification system can receive experience data comprising an experience score and unstructured text that is associated with the experience score. The experience classification system can provide the unstructured text to a theme-classifying machine-learning model to generate a theme classification, wherein the theme-classifying machine-learning model is trained to classify unstructured text into at least one theme from a defined taxonomy of themes. The experience classification system can then associate the theme classification for the unstructured text with the experience score.

As indicated above, the experience classification system can receive experience data comprising an experience score and unstructured text. For example, in some embodiments, the experience classification system can receive data from user surveys in which a user can submit a single score denoting their experience and freely enter text about the experience (e.g., a net promoter survey). In other embodiments, the experience classification system can receive experience data from third-party media information services. These third-party media information services can compile experience scores and unstructured text from various outlets where users supply information about a service, such as app reviews or social media services.

The experience classification system can then provide the unstructured text to a theme-classifying machine-learning model to generate a theme classification for the unstructured text. For example, the theme-classifying machine-learning model can be a machine-learning model trained to classify unstructured text into at least one theme classification from a defined taxonomy of themes. In some embodiments, providing the unstructured text to the theme-classifying machine-learning model comprises providing the unstructured text to multiple machine-learning models to generate a theme classification. For instance, the experience classification system can provide the unstructured text to a natural language processing machine-learning model (e.g., bidirectional encoder representations from transformers model) to receive classification embeddings. These classification embeddings can then be provided to the theme-classifying machine-learning model to generate a theme classification for the unstructured text. In other embodiments, the theme-classifying machine-learning model can be multilayer perceptron layers, a sentence transformer, a sentence transformer modified with logistic regression, a sentence transformer modified with a multilayer perceptron, a Siamese neural network, or a Siamese network modified with a multilayer perceptron.

As noted above, the experience classification system can generate a theme classification for unstructured text. For example, the experience classification system can generate a theme classification by selecting one or more themes from a defined taxonomy of themes denoting a general theme within the unstructured text. In addition to generating a theme classification, the experience classification system can also generate a subtheme classification associated with the theme classification. For instance, the experience classification system can generate a subtheme classification by selecting one or more subtheme classifications from a defined taxonomy of themes within the theme classification, where each subtheme classification is associated with the theme classification.

As previously noted, the experience classification system can associate the theme classification for the unstructured text with the experience score. For example, the experience classification system can store associated theme classifications and experience scores in a data table or other data structure. In some embodiments, associating the theme classification for the unstructured text with the experience score comprises associating a survey score (e.g., a net promoter survey score) to a theme classification generated from unstructured text input by the user when completing the survey. In other embodiments, associating the theme classification for the unstructured text with the experience score comprises associating a media experience score provided by a third-party media information service with a theme classification generated from unstructured text associated with the media information score.

The experience classification system can also suggest new theme classifications to add to the defined taxonomy of themes. For example, the experience classification system can utilize a theme-classifying machine-learning model to suggest additional theme classifications based on patterns found through analyzing multiple sets of unstructured text. In some embodiments, the experience classification system suggests additional subtheme classifications to add to a defined taxonomy of themes within an already defined theme classification.

Beyond determining theme classifications, the experience classification system can utilize a theme classification and associated experience score to perform additional actions. For example, in some embodiments, the experience classification system performs actions on a client device associated with the experience data. In other embodiments, the experience classification system can send notifications or links to educational materials to the client device associated with the experience data. In other embodiments, the experience classification system can send a notification to a customer service agent, notifying the customer service agent to contact a user associated with the client device that provided the experience data.

The experience classification system can also use the theme classification to determine actions that may correlate to an increase in an experience score. For example, the experience classification system can determine that a theme classification is associated with an experience score below a satisfaction threshold. The experience classification system can determine an action associated with the theme classification that, when performed, may correlate to an increase in the experience score. In other embodiments, the experience classification system can determine an action associated with a subtheme classification that, when performed, may correlate to an increase in the experience score.

The experience classification system provides several technical advantages over existing systems. For example, the experience classification system improves accuracy and efficiency relative to conventional systems. As noted above, some conventional systems are inaccurate in that they often categorize the user experience as a whole, while other systems receive feedback specific to a portion of the user experience but require tremendous time and computing resources because they require users to answer a variety questions across multiple graphical user interfaces. In contrast, the experience classification system can receive feedback specific to a portion of the user experience through a single graphical user interface. Because the experience classification system uses only a single graphical user interface to collect information, it takes far less time and computing resources than conventional systems. In addition, by utilizing a theme-classifying machine-learning model to generate theme classifications for unstructured text, the experience classification system can identify specific portions of the user experience expressed in unstructured text without biasing the user by prompting them with specific questions. Indeed, by classifying unstructured text into distinct theme classifications and associating it with the experience score, the experience classification system can determine specific features that a user may be unsatisfied with, increasing accuracy over conventional systems.

As previously noted, conventional systems are inaccurate as they only provide insights from a single customer experience survey and lose insights from customers that did not receive the survey. In contrast, the experience classification system utilizes a third-party media information service that provides unstructured text from a variety of sources with which users may share experiences (e.g., app reviews or social media). Since the experience classification system can take these valuable insights into account, it creates a more complete picture of the user experience, further increasing the accuracy of the experience classification system over conventional systems.

The experience classification system also increases flexibility over conventional systems because it can identify additional theme or subtheme classifications, unlike conventional systems that only gather information about known problems and issues. The experience classification system utilizes a theme-classifying machine-learning model that identifies patterns in the unstructured text and suggests additional theme and subtheme classifications. By suggesting additional classifications, the experience classification system is adaptable and better reflects the user experience over conventional systems.

As illustrated by the foregoing discussion, the present disclosure utilizes a variety of terms to describe features and benefits of the digital security system. Additional detail is now provided regarding the meaning of these terms. As used herein, the term “machine-learning model” refers to a computer algorithm or a collection of computer algorithms that automatically improve a particular task through experience based on the use of data. For example, a machine-learning model can improve accuracy and/or effectiveness by utilizing one or more machine-learning techniques. Example machine-learning models include various types of decision trees, support vector machines, Bayesian networks, or neural networks.

As mentioned, in some embodiments, the theme-classifying machine-learning model can be a neural network. The term “neural network” refers to a machine-learning model that can be trained and/or tuned based on inputs to determine classifications or approximate unknown functions. For example, a neural network includes a model of interconnected artificial neurons (e.g., organized in layers) that communicate and learn to approximate complex functions and generate outputs (e.g., generated digital images) based on a plurality of inputs provided to the neural network. In some cases, a neural network refers to an algorithm (or set of algorithms) that implements deep learning techniques to model high-level abstractions in data. For example, a neural network can include a convolutional neural network, a recurrent neural network (e.g., an LSTM), a graph neural network

In some cases, as previously noted, the experience classification system provides the unstructured text to a natural language processing machine-learning model. As used herein, the term “natural language processing machine-learning model” refers to a machine-learning model trained or used to detect human language. In some cases, the natural language processing machine-learning model refers to a trained machine-learning model that can make sense of written or spoken text and perform tasks. In some cases, the natural language processing machine-learning model is trained on large For example, a natural language processing machine-learning model can include a bidirectional encoder representations from transformers (BERT) model, a sentence transformer, a sentence transformer modified with logistic regression, a sentence transformer modified with a multilayer perceptron, a Siamese neural network, or a Siamese network modified with a multilayer perceptron.

As noted above, the machine-learning model comprises a theme-classifying machine-learning model. As used herein, the term “theme-classifying machine-learning model” refers to a machine-learning model trained to generate a theme classification. In some cases, the theme-classifying machine-learning model refers to a machine learning trained to classify unstructured text into one or more theme classifications from a defined taxonomy of themes. For example, the theme-classifying machine-learning model can utilize classification embeddings (e.g., from a natural language processing machine-learning model) to generate a theme classification for unstructured text.

As used herein, the term “experience data” refers to a collection of scores, text, or other data that contains information about a user experience with a system. In particular, the term “experience data” refers to information input by a user to relate their experience while using a system. In some embodiments, experience data comprises a survey response or set of survey responses from users of the system. In other embodiments, experience data can comprise data from sources in which a user may express their thoughts about their experience with a system, such as app reviews or social media.

As noted above, experience data can comprise an experience score. As used herein, the term “experience score” refers to a measure, classification, or metric indicating a level of satisfaction with an experience while using a system. In some embodiments, an experience score is directly input by a user of the system (e.g., as part of a net promoter score survey). In other embodiments, an experience score can be generated as part of a survey taken by a user of a system.

As further used herein, the term “unstructured text” refers to text freely inputted by a user of the system without specific prompts on what to input. In some embodiments, the unstructured text can be received as part of a survey, such as a net promoter score survey, wherein a user can simply write what they want about the system. In other embodiments, the unstructured text can come from sources where users may freely input information about a system, such as app reviews or social media.

As previously noted, the system may receive experience data from a third-party media information service. As used herein, the term “third-party media information service” refers to a service outside the experience classification system that collects experience data from sources where users may express their thoughts on a product or system. In some embodiments, the third-party media information system monitors areas of the internet where users often express their thoughts on products or services, such as social media or app reviews, for mentions of a certain product or service. For example, the third-party media information service can monitor for mentions of a brand name, products, keywords, hashtags, industry trends, or competitor names and gather unstructured text associated with user sentiments about the system.

In some cases, the third-party media information service can provide a media information score. As used herein, the term “media experience score” refers to a measure, classification, or metric indicating a level of user satisfaction and is associated with the experience data gathered by the third-party media information service. In some embodiments, the third-party media information service generates a media experience score based on analyzing sentiments shared (e.g., in app reviews, blogs, discussion forums, and other social media outlets). In other embodiments, the third-party media information service generates a media experience score based on an amount of user engagement, such as the number of mentions or the reach of the mentions (e.g., how many people saw the app review or a number of comments on social media).

As previously stated, the theme-classifying machine-learning model can generate a theme classification for unstructured text. As used herein, “theme classification” refers to a general category, class, or division that generally relates to the content or sentiment contained in the unstructured text. In particular, the term “theme classification” can include a certain product or service, an aspect of the user experience, an issue a user may encounter, or instances a user is pleased with a service. To illustrate, if unstructured text relates to a certain product or service, a theme classification can be a category about that product or service.

As also previously stated, the theme-classifying machine-learning model can generate a subtheme classification for unstructured text. As used herein, “subtheme classification” refers to categories, classes, or divisions that further distinguish a theme classification. In particular, the term “subtheme classification” can include categories, classes, or divisions that are more specific than the general theme classification. To illustrate, if a theme classification relates to a certain product or service, a subtheme classification can be certain portions of the product or service. For example, if a theme classification is related to account access, a subtheme classification could include, among others, password, sign-in, access, or create account.

As used herein, the term “taxonomy of themes” relates to a database, collection, or grouping of theme classifications organized with subtheme classifications corresponding to the theme classifications. In particular, the term “taxonomy of themes” can include a database or other collection which a theme-classifying machine-learning model can utilize to classify unstructured text. In some embodiments, the taxonomy of themes can include predefined theme classifications and subtheme classifications. In other embodiments, the taxonomy of themes can also include theme and subtheme classifications identified by the theme-classifying machine-learning model.

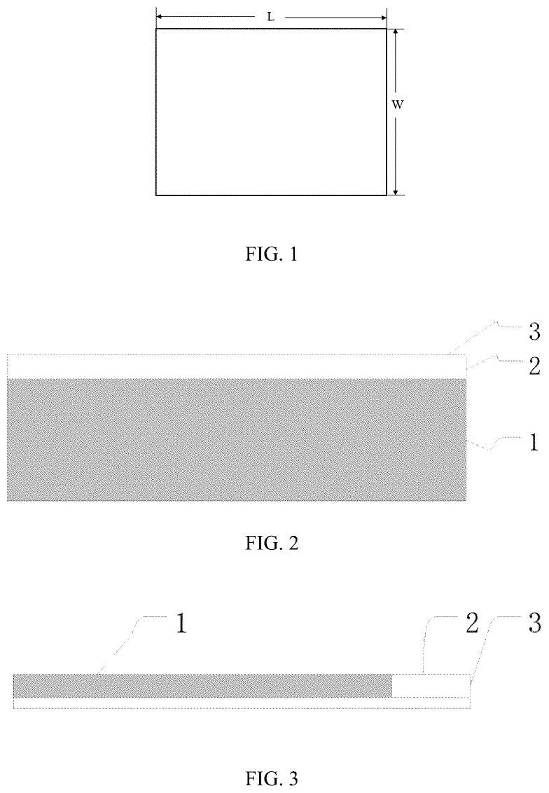

Additional detail regarding the intelligent fraud detection system will now be provided with reference to the figures. In particular, FIG. 1 illustrates a computing system environment for implementing an experience classification system in accordance with one or more embodiments. As shown in FIG. 1, the environment includes server(s) 106, client device(s) 110a-110n, and third-party media information service 114. Each of the components of the environment 100 communicate (or are at least configured to communicate) via network 116, and network 116 may be any suitable network over which computing devices can communicate. Example networks are discussed in more detail below in relation to FIGS. 8-9.

As further illustrated in FIG. 1, the environment 100 includes server(s) 106. In some embodiments, server(s) 106 comprises a content server and/or a data collection server. Additionally or alternatively, server(s) 106 comprises an application server, a communication server, a web-hosting server, a social networking server, a digital content management server, or a financial payment server.

Moreover, as shown in FIG. 1, the server(s) 106 implement an inter-network facilitation system 104. In one or more embodiments, the inter-network facilitation system 104 (or the experience classification system 102) communicates with the client device(s) 110a-110 (n) to receive experience data. More specifically, the inter-network facilitation system 104 (or the experience classification system) can communicate with one or more of the client devices 110a-110n to receive experience data comprising an experience score and unstructured text.

As additionally shown in FIG. 1, the experience classification system 102 implements a theme-classifying machine-learning model 108. The theme-classifying machine-learning model 108 generates theme classifications for unstructured text. Specifically, the theme-classifying machine-learning model 108 generates a theme classification for unstructured text by classifying unstructured text into at least one theme from a taxonomy of themes. Based on the theme classification, the experience classification system 102 can associate the theme classification with an experience score.

Further, the environment 100 includes the client devices 110a-110n. The client devices 110a-110n can include one of a variety of computing devices, including a smartphone, tablet, smart television, desktop computer, laptop computer, virtual reality device, augmented reality device, or other computing devices as described in relation to FIGS. 8-9. Although FIG. 1 illustrates only two client devices, the environment 100 can include many different client devices connected to each other via the network 116 (e.g., as denoted by the separating ellipses). Further, in some embodiments, the client devices 110a-110n receive user input and provide information pertaining to providing experience data to the server(s) 106.

Moreover, as shown, the client devices 110a-110n include corresponding client applications 112a-112n. The client applications 112a-112n can each include a web application, a native application installed on the client devices 110a-110n (e.g., a mobile application, a desktop application, a plug-in application, etc.), or a cloud-based application where part of the functionality is performed by the server(s) 106. In some embodiments, the experience classification system 102 causes the client applications 112a-112n to present or display information to a user associated with the client devices 110a-110n, including information relating to experience classification as provided in this disclosure.

The experience classification system 102 can also communicate with the third-party media information service 114 to provide information related to experience classification. In some embodiments, the experience classification system 102 receives experience data from the third-party media information service. For example, the experience classification system 102 can receive experience data comprising an experience score and unstructured text from the third-party media information service 114. In particular embodiments, the third-party media information service communicates with the client devices 110a-110n to receive experience data.

In some embodiments, though not illustrated in FIG. 1, the environment 100 has a different arrangement of components and/or has a different number or set of components altogether. For example, in certain embodiments, the client devices 110a-110n communicate directly with the server(s) 106, bypassing the network 116. As another example, in one or more embodiments, the environment 100 optionally includes a third-party server (e.g., that corresponds to the third-party media information service 114).

As mentioned above, the experience classification system 102 can efficiently and accurately generate theme classifications. In accordance with one or more embodiments, FIG. 2 illustrates the experience classification system 102 using a theme-classifying machine-learning model to generate a theme classification for unstructured text.

At an act 202 of FIG. 2, for example, the experience classification system 102 receives experience data. In particular, the experience classification system 102 receives experience data comprising an experience score and unstructured text. In some embodiments, the act 202 comprises receiving a response to a survey that includes unstructured text and an experience score from a net promoter score survey. In a net promoter score survey, the client device is presented, in a single graphical user interface, with a question about how likely they are to recommend a product, service, or good about which they are taking the survey, an option to select a number reflecting likely they are to recommend the product, service or good, and an option to enter unstructured text.

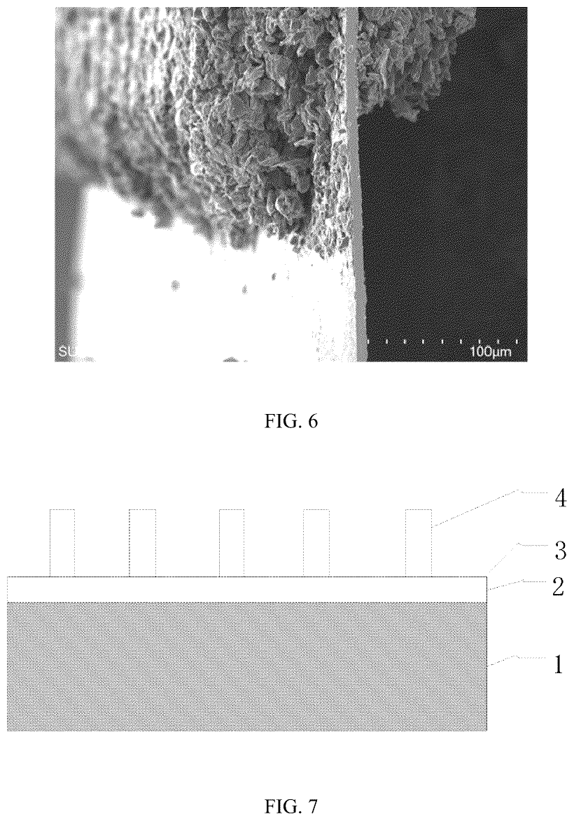

In some embodiments, the client device accesses the net promoter score survey through a unique hyperlink associated with the client device. In other embodiments, the client device accesses the net promoter score survey through a graphical user interface on the client device (e.g., through client application 112a). For example, the experience classification system 102 can send a graphical user interface to the client device, such as through a pop-up in the client application, with a net promoter score survey. In the single graphical user interface, the client device may enter an experience score by clicking on an option to select a number reflecting likely they are to recommend the product, service, or good and entering in unstructured text. By accessing a unique hyperlink or responding to a net promoter score survey from a client device, the experience classification system can associate the client device with the experience data. The experience classification system 102 can utilize this association to perform actions based on a generated theme classification from the unstructured text, as described in more detail with respect to FIG. 6.

In other embodiments, the act 202 comprises receiving, from a third-party media information service, experience data comprising unstructured text and a media experience score. For example, the third-party media information service can compile unstructured text from sources wherein a user may enter unstructured text relating to their experiences using a system, product, or good. In some cases, the third-party media information service utilizes social listening to identify what is being said about a system, product, or good on the internet. In other instances, third-party media information systems use software tools to gather unstructured text from any place on the internet where users may input unstructured text, such as in app reviews, blogs, discussion forums, and other social media outlets.

The third-party media information system can provide a media experience score along with the unstructured text. In some embodiments, the third-party media information service generates a media experience score by using natural language processing and other machine-learning tools to analyze the unstructured text and generate a score relating to the sentiments shared. In other embodiments, the third-party media information service generates a media experience score based on an amount of user engagement, such as the number of mentions or the reach of the mentions (e.g., how many people saw or commented on the app review or number of comments on social media).

The experience classification system 102 can also aggregate experience data from multiple sources. For example, the experience classification system 102 can aggregate experience data from the third-party media information service with data received from the net promoter score surveys.

As further illustrated in FIG. 2, at act 204, the experience classification system 102 provides unstructured text to a theme-classifying machine-learning model. More specifically, the experience classification system 102 provides the unstructured text to a theme-classifying machine-learning model trained to classify unstructured text into at least one theme from a defined taxonomy of themes. In some embodiments, the theme-classifying machine-learning model comprises multiple machine-learning models. For example, the experience classification system 102 can first provide the unstructured text to a natural language processing machine-learning model to analyze the unstructured text. In some embodiments, the natural language processing model is a bidirectional encoder representations from transformers (BERT) model, which may be modified or tuned to generate classification embeddings. These classification embeddings may then be provided to a theme-classifying machine-learning model. In some embodiments, the theme-classifying machine-learning model can be multilayer perceptron layers, a sentence transformer, a sentence transformer modified with logistic regression, a sentence transformer modified with a multilayer perceptron, a Siamese neural network, or a Siamese network modified with a multilayer perceptron.

As also shown in FIG. 2, at act 206, the experience classification system 102 generates a theme classification for the unstructured text. More specifically, the experience classification system 102 generates the theme classification by using the theme-classifying machine-learning model to assign the unstructured text into a theme from a defined taxonomy of themes. The experience classification system 102 can generate a single theme classification for the unstructured text, or if there are multiple sentiments or ideas expressed in the unstructured text, the experience classification system 102 can generate multiple theme classifications from the unstructured text (e.g., from the text entered into the single graphical user interface). For example, if the unstructured text contains sentiments or ideas that relate to both member service and account access, the experience classification system 102 can generate two theme classifications, one for each theme.

The experience classification system 102 can also generate a subtheme classification associated with the theme classification. More specifically, the experience classification system generates a subtheme classification by identifying sentiments or ideas within the unstructured text that relate to a subtheme from within the defined taxonomy of themes of the theme classification. For example, as shown in FIG. 2, the experience classification system 102 can generate a theme classification of member service with an associated subtheme of proficiency, wherein the proficiency subtheme relates to the proficiency of member service.

Moreover, the experience classification system 102 can generate multiple subtheme classifications from a single set of unstructured text (e.g., from the text entered in the single graphical user interface). More specifically, the experience classification system 102 can generate multiple subtheme classifications if the unstructured text relates to multiple subthemes within a theme classification. For example, the experience classification system 102 can generate a subtheme of proficiency, as shown in FIG. 2, but can also generate a subtheme of “helpful live agents” if that sentiment is also expressed in the unstructured text.

As further illustrated in FIG. 2, at act 208, the experience classification system 102 associated the theme classification with the experience score. More specifically, the experience classification system 102 can associate the theme classification and the experience score by storing them together. For example, the experience classification system can store the theme classification, and experience score in a table or other database wherein the computer associates them together.

As previously mentioned, the experience classification system 102 utilizes a theme-classifying machine-learning model to generate a theme classification for unstructured text. FIG. 3 illustrates the experience classification system 102 receiving unstructured text and utilizing and training the theme-classifying machine-learning model.

The experience classification system 102 can provide unstructured text to a theme-classifying machine-learning model to generate a theme classification for the unstructured text. In some embodiments, the theme-classifying machine model utilizes using several different machine-learning models to generate the theme classification for the unstructured text. For example, in some embodiments, the experience classification system 102 provides unstructured text to a natural language processing model to process the text and generate classification embeddings and then provides the classification embeddings to an embedding theme-classifying machine-learning model, which generates the theme classification. As illustrated in FIG. 3, the experience classification system 102 provides unstructured text 302 to natural language processing machine-learning model 304.

Natural language processing machine-learning model 304 can be any natural language processing model that receives and processes unstructured text in the same way as human language. For example, natural language processing machine-learning model 304 can be a bidirectional encoder representations from transformers (BERT) model. BERT is a natural language processing model trained on unlabeled, plain text (e.g., Wikipedia articles) by randomly masking a portion of the words and predicting those masked words and also by taking into account how sentences are related to each other by training for sentence prediction. As such, BERT is able to digest unstructured text and transform it into numbers (e.g., embeddings).

As shown in FIG. 3, the experience classification system 102 then provides the classification embeddings to embedding theme-classifying machine-learning model 308. The embedding theme-classifying machine-learning model can be one of many machine-learning models, such as multilayer perceptron layers, a sentence transformer, a sentence transformer modified with logistic regression, a sentence transformer modified with a multilayer perceptron, a Siamese neural network, or a Siamese network modified with a multilayer perceptron.

In certain embodiments, the experience classification system 102 utilizes an iterative training process to fit the embedding theme-classifying machine-learning model 308 by adjusting or adding decision trees or learning parameters that result in theme classifications. As illustrated in FIG. 3, the experience classification system 102 accesses training unstructured text 310. Training unstructured text 310 constitutes unstructured text relating to one or more themes and subthemes and is used to train the embedding theme-classifying machine-learning model 308. Training unstructured text 310 has a corresponding theme classification label 312 associated with it, where the theme classification label 312 indicates the theme classification that was previously determined. For example, the training unstructured text 310 could be text that was previously submitted to a team of researchers, and the researchers determined that training unstructured text 310 related to one or more theme classifications and subtheme classifications. Accordingly, in some cases, the experience classification system 102 treats the theme classification label 312 as a ground truth for training the embedding theme-classifying machine-learning model 308.

As further illustrated in FIG. 3, the embedding theme-classifying machine-learning model 308 generates a training theme classification 314 from the training unstructured text 310. More specifically, in some embodiments, the embedding theme-classifying machine-learning model 308 generates a set of theme classifications and subtheme classifications relating to sentiments contained in the training unstructured text 310. As described above, the training theme classification 314 can comprise a single theme classification and/or subtheme classification, or it can contain multiple theme classifications and/or subtheme classifications.

As also illustrated in FIG. 3, the experience classification system 102 utilizes a loss function 316 to compare the training theme classification 314 and the theme classification label 312 (e.g., to determine an error or a measure of loss between them). For instance, in cases where the embedding theme-classifying machine-learning model is an ensemble of gradient-boosted trees, the experience classification system 102 utilizes a mean squared loss function (e.g., for regression) and/or a logarithmic loss function (e.g., for classification) as the loss function 316.

By contrast, in embodiments where the embedding theme-classifying machine-learning model 308 is a neural network, the intelligent fraud detection system can utilize a cross-entropy loss function, an L1 loss function, or a mean squared error loss function as the loss function 316. For example, the experience classification system 102 utilizes the loss function 316 to determine a difference between the theme classification label 312 and the training theme classification 314.

As further illustrated in FIG. 3, the experience classification system 102 performs model fitting 318. In particular, the experience classification system 102 fits the embedding theme-classifying machine-learning model 308 based on loss from the loss function 316. For instance, the experience classification system 102 performs modifications or adjustments to the f embedding theme-classifying machine-learning model 308 to reduce the measure of loss from the loss function 316 for a subsequent training iteration.

For gradient-boosted trees, for example, the experience classification system 102 trains the embedding theme-classifying machine-learning model 308 on the gradients of errors determined by the loss function 316. For instance, the intelligent fraud detection system solves a convex optimization problem (e.g., of infinite dimensions) while regularizing the objective to avoid overfitting. In certain implementations, the experience classification system 102 scales the gradients to emphasize corrections to under-represented classes (e.g., fraud classifications or non-fraud classifications).

In some embodiments, the experience classification system 102 adds a new weak learner (e.g., a new boosted tree) to the embedding theme-classifying machine-learning model 308 for each successive training iteration as part of solving the optimization problem. For example, the experience classification system 102 finds a feature that minimizes a loss from the loss function 316 and either adds the feature to the current iteration's tree or starts to build a new tree with the feature

In addition to, or in the alternative, gradient-boosted decision trees, the experience classification system 102 trains a logistic regression to learn parameters for generating one or more theme classifications or subtheme classifications. To avoid overfitting, the experience classification system 102 further regularizes based on hyperparameters such as the learning rate, stochastic gradient boosting, the number of trees, the tree-depth(s), complexity penalization, and L1/L2 regularization

In embodiments where the embedding theme-classifying machine-learning model 308 is a neural network, the experience classification system 102 performs the model fitting 318 by modifying internal parameters (e.g., weights) of the embedding theme-classifying machine-learning model 308 to reduce the measure of loss for the loss function 316. Indeed, the experience classification system 102 modifies how the embedding theme-classifying machine-learning model 308 analyzes and passes data between layers and neurons by modifying the internal network parameters. Thus, over multiple iterations, the experience classification system 102 improves the accuracy of the embedding theme-classifying machine-learning model 308.

Indeed, in some cases, the experience classification system 102 repeats the training process illustrated in FIG. 3 for multiple iterations. For example, the experience classification system 102 repeats the iterative training by selecting a new set of training features for each set of training unstructured text along with a corresponding theme classification label. The experience classification system 102 further generates a new set of training theme classifications 314 for each iteration. As described above, the experience classification system 102 also compares a training theme classification 314 at each iteration with the corresponding theme classification label 312 and further performs model fitting 318. The experience classification system 102 repeats this process until the embedding theme-classifying machine-learning model 308 generates training theme classifications 314 that result in theme classifications that satisfy a threshold measure of loss.

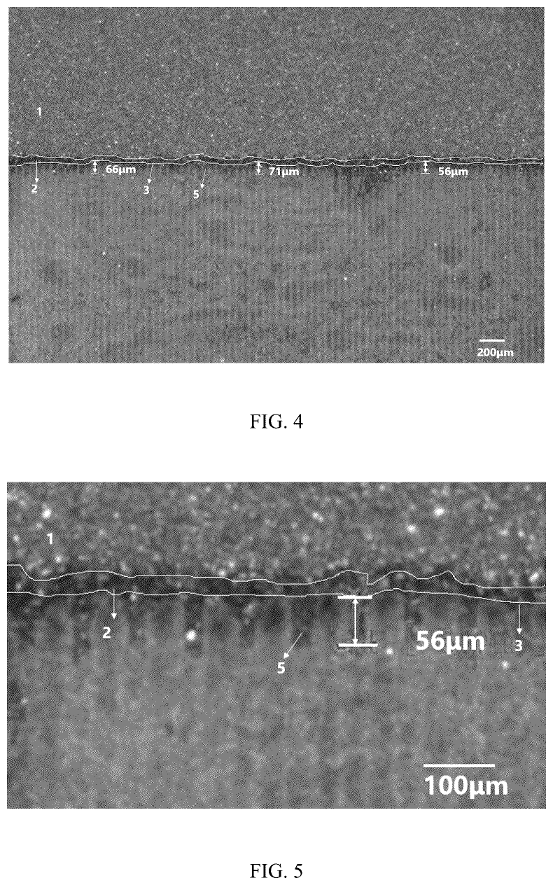

As stated above, the experience classification system 102 generates theme classifications by utilizing a theme-classifying machine-learning model to classify unstructured text into at least one theme from a defined taxonomy of themes. FIG. 4 illustrates a defined taxonomy of themes and generating suggested themes and subthemes to add to the defined taxonomy of themes.

As illustrated in FIG. 4, the experience classification system 102 can generate a theme classification by classifying text into at least one theme from a defined taxonomy of themes 404 by utilizing theme-classifying machine-learning model 402, trained to classify text into at least one theme from a defined taxonomy of themes 404. In some embodiments, the defined taxonomy of themes 404 is a grouping of themes comprising categories of experiences and products relating to a customer experience with a system (e.g., the inter-network facilitation system 104). More particularly, the themes in the defined taxonomy of themes can relate to praises or issues that are likely to be expressed in the unstructured text from client responses, such as text from a net promoter score survey or compiled from various review and social media outlets (e.g., by the third-party media information service).

The defined taxonomy of themes 404 can relate to a variety of different aspects of the user experience. For example, as illustrated, the defined taxonomy of themes 404 could be account access, deposit, cash withdrawal, savings account, member service, ATM, tech, interest rate, security concern, dispute, fees, transactions, interoperability, or feature request. Indeed, the themes in the defined taxonomy of themes 404 can cover a broad range of the user experience within a system (e.g., the inter-network facilitation system 104).

The experience classification system 102 can also classify text into one or more subthemes from the defined taxonomy of themes 404. More specifically, while a theme can relate to a general product, service, or experience, a subtheme can relate to more particular portions of the product, service, or experience. For example, as illustrated, a theme could include the general category of account access with related subthemes of sign-in/access account, sign up/create account, phone number related, activation, password, update account info, using multiple devices, and verification/2FA, among others.

The experience classification system 102 can also classify unstructured text into multiple themes and/or subthemes from the defined taxonomy of themes. More specifically, the experience classification system 102 can identify if unstructured text expresses more than one idea or sentiment about a product, good, or service and classify the text into multiple themes or subthemes. The experience classification system 102 can classify unstructured text into any number of themes and subthemes, as long as the unstructured text expresses the idea of sentiment of the theme(s) and/or subtheme(s). For example, the experience classification system 102 can classify unstructured text into a single theme and multiple subthemes.

The experience classification system 102 can also classify the unstructured text into a theme without a corresponding subtheme. More specifically, the experience classification system 102 can identify that the unstructured text expressed a certain idea or sentiment that corresponds to a theme but does not correspond to any particular subtheme associated with the theme. As an example, the experience classification system 102 could identify that unstructured text corresponds to the theme of “security concern,” as illustrated in FIG. 4, but does not identify with the defined subtheme of “protected.” In this case, the experience classification system 102 could generate a theme classification of “security concern” and would not generate a subtheme classification.

In some embodiments, the defined taxonomy of themes 404 is populated with themes and subthemes preselected based on previously identified issues or praises about products, services, or goods. More specifically, the defined taxonomy of themes can be populated with themes and subthemes identified from addressing previous issues or praises. For example, preselected themes and subthemes can be added based on previous customer support requests or things that are frequently addressed in customer support sessions.

In other embodiments, as illustrated in FIG. 4, the experience classification system 102 can suggest additional themes to add to the defined taxonomy of themes 404. More specifically, as the experience classification system 102 utilizes theme-classifying machine-learning model 402 to classify unstructured text, theme-classifying machine-learning model 402 can also identify ideas or sentiments that are expressed in multiple sets of unstructured text at a threshold frequency and offer additional themes to add to the defined taxonomy of themes 404. For example, as illustrated, if the theme-classifying machine-learning model 402 identifies that several sets of unstructured text have mentioned or expressed the “Spot Me Service” at the threshold frequency, the theme-classifying machine-learning model 402 can suggest a theme 406 to add “Spot Me Service” to the defined taxonomy of themes 404. In some embodiments, the experience classification system 102 automatically adds suggested themes. In other embodiments, the experience classification system 102 only adds suggested themes upon receiving an approval to add the suggested theme. For example, an administrator device within the inter-network facilitation system 104 could send an approval notification to the experience classification system that confirms the suggested theme can be added to the defined taxonomy of themes 404.

The experience classification system 102 can further suggest subthemes to add within an existing theme in the defined taxonomy of themes 404. More specifically, in addition to utilizing the theme-classifying machine model to classify unstructured text, the experience classification system 102 can utilize the theme-classifying machine-learning model 404 to identify ideas or sentiments that are related to a previously added theme but that are not already included as a subtheme associated with that theme. For example, as illustrated, the experience classification system can determine that unstructured text associated with the theme “security concern” often expresses the sentiment, idea, or feedback of “feels safe.” In response, the experience classification system 102 can suggest adding a subtheme of “feels safe” associated with the theme of “security concern” to the defined taxonomy of themes 404

The experience classification system 102 can also determine features that clients would like added to the inter-network facilitation system 104. More specifically, as the experience classification system 102 utilizes theme-classifying machine-learning model 402 to classify unstructured text, the theme-classifying machine-learning model 402 can be tuned to identify features that are not present in the system. For example, as illustrated, the experience classification system 102 can determine that unstructured text often expressed the sentiment or idea of adding lending to the inter-network facilitation system 104. In response, the experience classification system 102 can suggest a subtheme of “lending” to add to the defined taxonomy of themes 404 associated with the theme of “feature requests.” Indeed, in this way the experience classification system 102 can identify features that clients of the system would like to see added in the future without using additional computing resources.

As mentioned above, in some embodiments, the experience classification system 102 can associate the theme classification to the experience score and take other actions based on the theme classification. FIG. 5 illustrates the experience classification system associating the theme classification and experience score, along with performing and determining additional actions based on the theme classification.

In some embodiments, the experience classification system 102 can associate an experience score and the theme classification in a way they can be easily digested together. More specifically, the experience classification system 102 stores the experience score and the theme classification by storing them together in a data table or other structure. As shown in FIG. 5, the theme classification 502 can be stored together in rows where the data is seen easily together and can be easily consumed by other computer programs.

The experience classification system 102 can further associate the unstructured text to a subtheme associated with the theme classification. More specifically, if the experience classification system 102, using a theme-classifying machine-learning model, determines that the unstructured text is associated with a subtheme, the experience classification system 102 can associate the subtheme together with the theme classification and experience score. As shown in FIG. 5, the experience classification system 102 can associate the experience score, theme classification, and subtheme classification by storing them in a data table. As further illustrated in FIG. 5, the experience classification system 102 can also associate the theme classification, subtheme classification, and experience score with the unstructured text. Moreover, though the associations are shown in a certain arrangement, one will understand that the experience score, unstructured text, theme classification, and subtheme classification can be associated with any number of arrangements.

As noted above, the experience classification system 102 can also determine or take further actions based on the theme classification or the subtheme classification. For example, the experience classification system 102 can execute act 504 and perform an action based on the theme classification and associated experience score. In some embodiments, the experience classification system 102 can send a notification to a client device associated with the unstructured text. In other embodiments, the experience classification system 102 can determine to send a notification to an agent of the inter-network facilitation system 104 notifying the agent of potential issues or praises. In still other embodiments, the experience classification system 102 can send education materials to the client device associated with the unstructured text. Performing actions based on the theme classification and associated experience score will be discussed further in FIG. 6.

The experience classification system 102 can also determine actions to take based on the theme classification and associated experience score. More specifically, the experience classification system 102 can determine actions specific to the theme classification based on the associated theme classification and experience score. For example, as illustrated, if the experience classification system 102 generates a theme classification of “member service,” the experience classification system 102 can determine an action based on the theme classification 506 and by determining to add more agents to the service line.

Further, in some embodiments, the experience classification system 102 determines actions to take based on the value of the experience score in correlation with the theme classification. More specifically, the experience classification system 102 can determine that the experience score satisfies an action determination threshold and determine an action to take based on the experience score satisfying the action determination threshold. An action determination threshold can be a metric that, when satisfied, denotes that the experience score is at a suboptimal level. The experience classification system 102 can then determine an action. In some embodiments, the action determination threshold is a certain value of the experience score that, when satisfied, prompts the experience classification system to determine an action. In other embodiments, the action determination threshold can have several different levels based on the value of the experience score. For example, the action determination threshold can have an “action” level if the experience score is between certain values, such as 6-7, an “urgent action” level if the experience score is between other values, such as 3-5, and an “immediate action” level if the experience score is between even more values, such as 0-2.

In other embodiments, the experience classification system 102 can also determine actions based on an aggregate experience score representing experience scores associated with a theme classification. More specifically, the experience classification system 102 can generate an aggregated experience score representing an average of experience scores associated with a theme classification, based on the aggregated experience score for the theme classification, to determine an action. For example, as illustrated, the experience classification system 102 can determine to increase the number of member service agents if the aggregated experience score satisfies an aggregated experience score action threshold denoting that the aggregated experience score is above or below a certain level for the theme classification.

The experience classification system 102 can also determine actions to take based on the subtheme classification. More specifically, the experience classification system 102 can determine actions specific to the subtheme classification based on the associated subtheme classification and experience score. For example, as illustrated, if the experience classification system 102 generates a theme classification of “ATM” and a subtheme classification of “ATM locations,” the experience classification system 102 can determine to increase the number of ATM locations.

Further, in some embodiments, the experience classification system 102 determines actions to take based on the value of the experience score in correlation with the subtheme classification. More specifically, the experience classification system 102 can determine that the experience score satisfies a subtheme action determination threshold and determine an action to take based on the experience score satisfying the subtheme action determination threshold. A subtheme action determination threshold can be a metric that, when satisfied, denotes that the experience score is at a sub-optimal level for the given subtheme. The experience classification system 102 can then determine an action appropriate for the value of the experience score. In some embodiments, the subtheme action determination threshold is a certain value of the experience score that, when satisfied, prompts the experience classification system to determine an action. In other embodiments, the subtheme action determination threshold can have several different levels based on the value of the experience score. For example, the subtheme action determination threshold can have an “action” level if the experience score is between certain values, such as 6-7, an “urgent action” level if the experience score is between other values, such as 3-5, and an “immediate action” level if the experience score is between even more values, such as 0-2.

In other embodiments, the experience classification system 102 can also determine actions based on an aggregate experience score representing experience scores associated with a subtheme classification. More specifically, the experience classification system 102 can generate an aggregated experience score representing an average of experience scores associated with a given subtheme classification and, based on the aggregated experience score for the subtheme classification, determine an action. For example, as illustrated, the experience classification system 102 can determine to increase the number of ATM locations if the aggregated experience score satisfies an aggregated experience score action threshold denoting that the aggregated experience score is above or below a certain level for the subtheme classification.

The experience classification system 102 can also make predictions about the experience score based on performing a determined action. More specifically, the experience classification system can determine that, by performing a determined action based on a theme classification, there will be an increase in the experience score 508. For example, as illustrated, if an experience score associated with a theme classification (e.g., member service) is a 7, the experience classification system 102 can predict that by adding more member service agents, there will be an increase in the experience score.

In other embodiments, the experience classification system 102 can determine that, by performing a determined action based on a subtheme classification, there will be an increase in the experience score 512. For example, as illustrated, if an experience score associated with a subtheme classification (e.g., ATM locations) is a 7, the experience classification system 102 can predict that by adding more ATM locations, there will be an increase in the experience score.

As noted above, the experience classification system can perform actions based on the theme classification. FIG. 6 illustrates the experience classification system 102 performing actions based on the theme classification.

The experience classification system can perform actions based on the value of the experience score and the associated theme classification 602. More specifically, the experience classification system 102 can identify that an experience score is associated with a theme classification and that the value of the experience score is below an action performance threshold. In some embodiments, the action determination threshold is a value of the experience score that, when satisfied, prompts the experience classification system to perform an action correlated with the theme classification. For example, if the action performance threshold is 5, the experience score is 3, and the experience score is associated with a theme classification and/or a subtheme classification, the experience classification system 102 can determine that the action performance threshold is satisfied and perform an action associated with the theme classification.

In some embodiments, the experience classification system 102 can send a notification 604 corresponding to the theme classification and/or subtheme classification. More specifically, the experience classification system 102 can determine that the value of the experience score satisfies an action performance threshold and send a notification correlated with an associated theme or subtheme classification. For example, the experience classification system 102 can determine that an experience score of 2 satisfies an action performance threshold and perform an action based on the associated theme classification of deposit. In other embodiments, the experience classification system 102 can determine that an experience score of 2 satisfies an action performance threshold and perform an action based on the subtheme classification of weekend/holiday.

The experience classification 102 can also determine that a client device is associated with the submitted experience score and send a notification to the client device. In some embodiments, the experience classification system 102 sends a notification to the client device (e.g., client device 110a) through a client application (e.g., client application 110n), such as by push notification. In other embodiments, the experience classification system 102 sends a notification to the client device through other notification systems on the client device, such as through email or text message.

In addition, based on the theme or subtheme, the experience classification system 102 can access a client account before sending a notification. More specifically, by accessing the client account, the experience classification system 102 can identify additional information and generate a notification relating to the theme or subtheme based on information accessed in the client account and send the notification to the client device. For example, if the experience classification system 102 identifies that the experience score of 2 meets an action performance threshold and is associated with the theme “deposit” and the subtheme “Weekend/holiday,” the experience classification system 102 can access a client account associated with the client device that submitted the experience score. Based on accessing the client account, the experience classification system 102 can determine that there was a deposit made to the client account on a weekend and generate a notification about the deposit to send to the client device.

The experience classification system 102 can also send a notification to an agent of the inter-network facilitation system. More specifically, if the value of the experience score is below an agent notification threshold, the experience classification system 102 can send a notification to an agent of the inter-network facilitation system 606 informing the agent of the associated experience score and theme classification. In some embodiments, the experience classification system 102 will notify an agent when the value of an experience score is below the agent notification threshold. In other embodiments, the experience classification system 102 will notify an agent when the experience score is below the agent notification threshold and based on the theme classification or subtheme with which the experience score is associated. For example, the experience classification system 102, as illustrated, an experience score of 4 can be associated with the theme “member service” and the subtheme “issue not resolved.” If the experience score is below an agent notification threshold (e.g., below 5), the experience classification system 102 can notify the agent because the low experience score is associated with the subtheme “issue not resolved.”

Moreover, the experience classification system 102 can also send education materials based on the theme classification. More specifically, the experience classification system 102 can send education materials 608 with information related to the theme classification to a client device associated with the unstructured text. In some embodiments, the experience classification system 102 sends education materials 608 to an email associated with the client device that submitted the experience data (e.g., answered a net promoter score survey). For example, the client device can submit experience data by responding to a net promoter score survey invitation by clicking a unique hyperlink that identifies the client device. Based on the theme classification generated from the unstructured data submitted with the net promoter score survey, the experience classification system 102 can send education materials to the client device.

In some embodiments, experience classification system 102 can send educational materials specific to the generated theme classification or subtheme classification. For example, as illustrated, if the experience classification system 102 generates the theme classification “account access,” the experience classification system 102 can send educational materials about troubleshooting account access issues. In another example, as illustrated, if the experience classification system 102 generates a subtheme classification of “signup/create account” associated with the theme of “account access,” the experience classification system 102 can send education materials associated with troubleshooting account sign-up issues.

In other embodiments, the experience classification system 102 can send education materials based on the theme classification or subtheme classification and if the value of the experience score satisfies an education material threshold. For example, as illustrated, if the experience classification system 102 generates a theme classification “account access” and the subtheme classification “signup/create account,” and if an experience score of 3 satisfies the send education threshold, then the experience classification system can send materials to the client device associated with the experience data related to the theme classification.

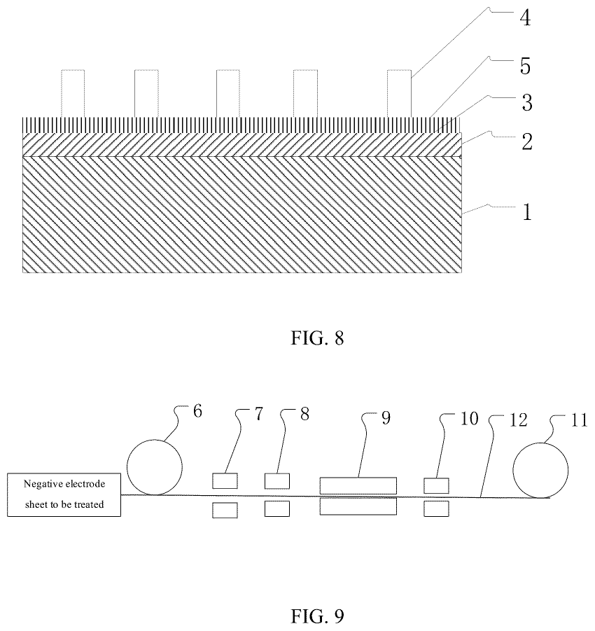

FIGS. 1-6, the corresponding text, and the examples provide a number of different systems, methods, and non-transitory computer-readable media for generating a theme classification for a unstructured text utilizing a theme-classifying machine-learning model. In addition to the foregoing, embodiments can also be described in terms of flowcharts comprising acts for accomplishing a particular result. For example, FIG. 7 illustrates a flowchart of an example sequence of acts in accordance with one or more embodiments.

While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer-readable storage medium can comprise instructions that, when executed by one or more processors, cause a computing device to perform the acts depicted in FIG. 7. In still further embodiments, a system comprising at least one processor and a non-transitory computer-readable medium comprising instructions that, when executed by one or more processors, cause the system to perform the acts of FIG. 7.

FIG. 7 illustrates an example series of acts 700 for generating a theme classification for a unstructured text utilizing a theme-classifying machine-learning model. As shown in FIG. 7, the series of acts 700 can include an act 702 of receiving experience data. In particular, the act 702 can involve receiving experience data comprising an experience score associated with unstructured text. In some embodiments, the act 702 of receiving experience data comprises receiving a response to a net promoter score survey comprising a net promoter score and receiving the unstructured text associated with the net promoter score survey. In other embodiments, receiving experience data comprising an experience score and unstructured text comprises receiving, from a third-party media information service, a media experience score and receiving, from the third-party media information service, unstructured text associated with the media experience score.

As shown, the series of acts 700 can also include the act 704 of providing unstructured text. In particular, the act 704 can include providing unstructured text to a theme-classifying machine-learning model, the theme-classifying machine-learning model trained to classify unstructured text into at least one theme from a defined taxonomy of themes.

Further, the series of acts 700 can include an act 706 of receiving a theme classification. In particular, the act 706 can involve generating, using a theme-classifying machine-learning model, a theme classification for the unstructured text.

As further illustrated in FIG. 7, the series of acts 700 can include an act 708 of associating the theme classification with the experience score. In particular, the act 708 can involve associating the theme classification for the unstructured text with the experience score. In some embodiments, associated the theme classification with the experience score comprises associate the theme classification with a net promoter score.

In some embodiments, the series of acts 700 includes an act of determining, utilizing the theme-classifying machine-learning model, a subtheme classification associated with the at least one theme classification, and associating the subtheme classification and the theme classification with the experience score.

The series of acts 700 can further include an act of receiving, using the theme-classifying machine-learning model, an additional theme classification and an additional subtheme classification for the unstructured text, and associating, in combination with the theme classification, the additional theme classification and the theme classification with the experience score.

The series of acts 700 can also include providing the unstructured text to a natural language processing model, receiving, from the natural language processing model, classification embeddings, and providing the classification embeddings to the theme-classifying machine-learning model to receive the theme classification for the unstructured text. In some embodiments, the natural language processing model comprises a bidirectional encoder representations from transformers (BERT) model. In some cases, the theme-classifying machine-learning model comprises one of a sentence transformer, a sentence transformer modified with a logistic regression, a sentence transformer modified with a multilayer perceptron, a Siamese neural network, or a Siamese network modified with a multilayer perceptron.

The series of acts 700 can further include receiving, from the theme-classifying machine-learning model and based on the unstructured text, a suggested theme to add to the defined taxonomy of themes and adding the suggested theme to the defined taxonomy of themes. In other embodiments, the series of acts 700 can include receiving, from the theme-classifying machine-learning model, one or more suggested subthemes associated with a given theme in the defined taxonomy of themes and associating the one or more subthemes with the given theme in the defined taxonomy of themes.

The series of acts 700 can also include performing an action based on the associated theme classification and experience sore. Additionally, the series of acts 700 can also include determining an action to perform based on the theme classification and predicting that performing the determined action with correlate to an increase in the experience score. In other embodiments, the series of acts 700 includes determining, utilizing the theme-classifying machine-learning model, a subtheme classification associated with the at least one theme classification, determining an action to perform based on the subtheme classification and predicting that performing the determined action will correlate to an increase in the experience score.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 8 illustrates a block diagram of an example computing device 800 that may be configured to perform one or more of the processes described above. One will appreciate that one or more computing devices, such as the computing device 800 may represent the computing devices described above (e.g., computing device 800, server device 106 and client devices 110a-n). In one or more embodiments, the computing device 800 may be a mobile device (e.g., a mobile telephone, a smartphone, a PDA, a tablet, a laptop, a camera, a tracker, a watch, a wearable device, etc.). In some embodiments, the computing device 800 may be a non-mobile device (e.g., a desktop computer or another type of client device). Further, the computing device 800 may be a server device that includes cloud-based processing and storage capabilities.

As shown in FIG. 8, the computing device 800 can include one or more processor(s) 802, memory 804, a storage device 806, input/output interfaces 808 (or “I/O interfaces 808”), and a communication interface 810, which may be communicatively coupled by way of a communication infrastructure (e.g., bus 812). While the computing device 800 is shown in FIG. 8, the components illustrated in FIG. 8 are not intended to be limiting. Additional or alternative components may be used in other embodiments. Furthermore, in certain embodiments, the computing device 800 includes fewer components or more components than those shown in FIG. 8. Components of the computing device 800 shown in FIG. 8 will now be described in additional detail.

In particular embodiments, the processor(s) 802 includes hardware for executing instructions, such as those making up a computer program. As an example, and not by way of limitation, to execute instructions, the processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, the storage device 806 can include a non-transitory storage medium described above. The storage device 806 may include a hard disk drive (HDD), flash memory, a Universal Serial Bus (USB) drive or a combination these or other storage devices.

As shown, the computing device 800 includes one or more I/O interfaces 808, which are provided to allow a user to provide input to (such as user strokes), receive output from, and otherwise transfer data to and from the computing device 800. These I/O interfaces 808 may include a mouse, keypad or a keyboard, a touch screen, camera, optical scanner, network interface, modem, other known I/O devices or a combination of such I/O interfaces 808. The touch screen may be activated with a stylus or a finger.

The I/O interfaces 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 808 are configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 provides one or more interfaces for communication (such as, for example, packet-based communication) between the computing device and one or more other computing devices or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI. The computing device 800 can further include a bus 812. The bus 812 can include hardware, software, or both that connects components of computing device 800 to each other.

FIG. 9 illustrates an example network environment 900 of the inter-network facilitation system 104. The network environment 900 includes a client device 906 (e.g., client devices 110a-110n), an inter-network facilitation system 104, and a third-party system 908 connected to each other by a network 904. Although FIG. 9 illustrates a particular arrangement of the client device 906, the inter-network facilitation system 104, the third-party system 908, and the network 904, this disclosure contemplates any suitable arrangement of client device 906, the inter-network facilitation system 104, the third-party system 908, and the network 904. As an example, and not by way of limitation, two or more of client device 906, the inter-network facilitation system 104, and the third-party system 908 may communicate directly, bypassing network 904. As another example, two or more of client device 906, the inter-network facilitation system 104, and the third-party system 908 may be physically or logically co-located with each other in whole or in part.

Moreover, although FIG. 9 illustrates a particular number of client devices 906, inter-network facilitation systems 104, third-party systems 908, and networks 904, this disclosure contemplates any suitable number of client devices 906, inter-network facilitation system 104, third-party systems 908, and networks 904. As an example, and not by way of limitation, network environment 900 may include multiple client devices 906, inter-network facilitation system 104, third-party systems 908, and/or networks 904.

This disclosure contemplates any suitable network 904. As an example, and not by way of limitation, one or more portions of network 904 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 904 may include one or more networks 904.

Links may connect client device 906, the inter-network facilitation system 104 (which hosts the fee-free credit withdrawal system 102), and third-party system 908 to network 904 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 900. One or more first links may differ in one or more respects from one or more second links.

In particular embodiments, the client device 906 may be an electronic device including hardware, software, or embedded logic components or a combination of two or more such components and capable of carrying out the appropriate functionalities implemented or supported by client device 906. As an example, and not by way of limitation, a client device 906 may include any of the computing devices discussed above in relation to FIG. 8. A client device 906 may enable a network user at the client device 906 to access network 904. A client device 906 may enable its user to communicate with other users at other client devices 906.

In particular embodiments, the client device 906 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 906 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 906 one or more Hyper Text Markup Language (“HTML”) files responsive to the HTTP request. The client device 906 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 904) to link the third-party system 908. For example, the inter-network facilitation system 104 may receive authentication credentials from a user to link a third-party system 908 such as an online bank account, credit account, debit account, or other financial account to a user account within the inter-network facilitation system 104. The inter-network facilitation system 104 can subsequently communicate with the third-party system 908 to detect or identify balances, transactions, withdrawal, transfers, deposits, credits, debits, or other transaction types associated with the third-party system 908. The inter-network facilitation system 104 can further provide the aforementioned or other financial information associated with the third-party system 908 for display via the client device 906. In some cases, the inter-network facilitation system 104 links more than one third-party system 908, receiving account information for accounts associated with each respective third-party system 908 and performing operations or transactions between the different systems via authorized network connections.

In particular embodiments, the inter-network facilitation system 104 may interface between an online banking system and a credit processing system via the network 904. For example, the inter-network facilitation system 104 can provide access to a bank account of a third-party system 908 and linked to a user account within the inter-network facilitation system 104. Indeed, the inter-network facilitation system 104 can facilitate access to, and transactions to and from, the bank account of the third-party system 908 via a client application of the inter-network facilitation system 104 on the client device 906. The inter-network facilitation system 104 can also communicate with a credit processing system, an ATM system, and/or other financial systems (e.g., via the network 904) to authorize and process credit charges to a credit account, perform ATM transactions, perform transfers (or other transactions) across accounts of different third-party systems 908, and to present corresponding information via the client device 906.

In particular embodiments, the inter-network facilitation system 104 includes a model for approving or denying transactions. For example, the inter-network facilitation system 104 includes a transaction approval machine-learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 908), the inter-network facilitation system 104 can utilize the transaction approval machine-learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 900 either directly or via network 904. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 906, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 904.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles and/or account information for credit accounts, secured accounts, secondary accounts, and other affiliated financial networking system accounts. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 906. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 906. Information may be pushed to a client device 906 as notifications, or information may be pulled from client device 906 responsive to a request received from client device 906. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 906 associated with users.

In addition, the third-party system 908 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 904. A third-party system 908 can communicate with the inter-network facilitation system 104 to provide financial information pertaining to balances, transactions, and other information, whereupon the inter-network facilitation system 104 can provide corresponding information for display via the client device 906. In particular embodiments, a third-party system 908 communicates with the inter-network facilitation system 104 to update account balances, transaction histories, credit usage, and other internal information of the inter-network facilitation system 104 and/or the third-party system 908 based on user interaction with the inter-network facilitation system 104 (e.g., via the client device 906). Indeed, the inter-network facilitation system 104 can synchronize information across one or more third-party systems 908 to reflect accurate account information (e.g., balances, transactions, etc.) across one or more networked systems, including instances where a transaction (e.g., a transfer) from one third-party system 908 affects another third-party system 908.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving experience data comprising an experience score associated with unstructured text;
providing the unstructured text to a theme-classifying machine-learning model, the theme-classifying machine-learning model trained to classify unstructured text into at least one theme from a defined taxonomy of themes;
generating, using the theme-classifying machine-learning model, a theme classification for the unstructured text; and
associating the theme classification for the unstructured text with the experience score.

2. The computer-implemented method of claim 1, further comprising:
determining, utilizing the theme-classifying machine-learning model, a subtheme classification associated with the at least one theme classification; and
associating the subtheme classification and the theme classification with the experience score.

3. The computer-implemented method of claim 1, wherein receiving experience data comprising an experience score associated with unstructured text comprises:
receiving a response to a net promoter score survey comprising a net promoter score; and
receiving the unstructured text associated with the net promoter score survey.

4. The computer-implemented method of claim 3, wherein associating the theme classification with the experience score comprises associating the theme classification with the net promoter score.

5. The computer-implemented method of claim 1, wherein receiving experience data comprising an experience score associated with unstructured text comprises:
receiving, from a third-party media information service, a media experience score; and
receiving, from the third-party media information service, unstructured text associated with the media experience score.

6. The computer-implemented method of claim 1, further comprising:
providing the unstructured text to a natural language processing model;
receiving, from the natural language processing model, classification embeddings; and
providing the classification embeddings to the theme-classifying machine-learning model to receive the theme classification for the unstructured text.

7. The computer-implemented method of claim 6, wherein the natural language processing model comprises a bidirectional encoder representations from transformers (BERT) model.

8. The computer-implemented method of claim 1, wherein the theme-classifying machine-learning model comprises one of a sentence transformer, a sentence transformer modified with a logistic regression, a sentence transformer modified with a multilayer perceptron, a Siamese neural network, or a Siamese network modified with a multilayer perceptron.

9. The computer-implemented method of claim 1, further comprising:
receiving, from the theme-classifying machine-learning model and based on the unstructured text, a suggested theme to add to the defined taxonomy of themes; and
adding the suggested theme to the defined taxonomy of themes.

10. A non-transitory computer-readable medium storing instructions that, when executed by at least one processor, cause a computer system to:
receive experience data comprising an experience score associated with unstructured text;
provide the unstructured text to a theme-classifying machine-learning model, the theme-classifying machine-learning model trained to classify unstructured text into at least one theme from a defined taxonomy of themes;
generate, using the theme-classifying machine-learning model, a theme classification for the unstructured text; and
associate the theme classification for the unstructured text with the experience score.

11. The computer-readable medium of claim 10 further comprising instructions that, when executed by the at least one processor, cause the computer system to:
determine, utilizing the theme-classifying machine-learning model, a subtheme classification associated with the at least one theme classification; and
associate the subtheme classification and the theme classification with the experience score.

12. The computer-readable medium of claim 10 further comprising:
receiving, using the theme-classifying machine-learning model, an additional theme classification and an additional subtheme classification for the unstructured text; and
associating, in combination with the theme classification, the additional theme classification and the additional subtheme classification with the experience score.

13. The computer-readable medium of claim 10, further comprising instructions that, when executed by the at least one processor, cause the computer system to:
receiving, from the theme-classifying machine-learning model, one or more suggested subthemes associated with a given theme in the defined taxonomy of themes; and
associating the one or more subthemes with the given theme in the defined taxonomy of themes.

14. The computer-readable medium of claim 10, further comprising instructions that, when executed by the at least one processor, cause the computer system to perform an action based on the associated theme classification and experience score.

15. The computer-readable medium of claim 10, further comprising instructions that, when executed by the at least one processor, cause the computer system to:
determine an action to perform based on the theme classification; and
predict that performing the determined action will correlate to an increase in the experience score.

16. A system comprising:
at least one processor; and
at least one non-transitory computer-readable storage medium storing instructions that, when executed by the at least one processor, cause the system to:
receive experience data comprising an experience score associated with unstructured text;
provide the unstructured text to a theme-classifying machine-learning model, the theme-classifying machine-learning model trained to classify unstructured text into at least one theme from a defined taxonomy of themes;
generate, using the theme-classifying machine-learning model, a theme classification for the unstructured text; and
associate the theme classification for the unstructured text with the experience score.

17. The system of claim 16, further comprising instructions that, when executed by the at least one processor, cause the system to:
determine, utilizing the theme-classifying machine-learning model, a subtheme classification associated with the at least one theme classification; and
associate the subtheme classification and the theme classification with the experience score.

18. The system of claim 16, further comprising instructions that, when executed by the at least one processor, cause the system to perform an action based on the associated theme classification and experience score.

19. The system of claim 18, further comprising instructions that, when executed by the at least one processor, cause the system to:
determine, utilizing the theme-classifying machine-learning model, a subtheme classification associated with the at least one theme classification;
determine an action to perform based on the subtheme classification; and
predict that performing the determined action will correlate to an increase in the experience score.

20. The system of claim 16, wherein receiving experience data comprising an experience score associated with unstructured text comprises:
receiving a response to a net promoter score survey comprising a net promoter score; and
receiving the unstructured text associated with the net promoter score survey.
